(19) United States
(12) Patent Application Publication
(10) Pub. No.: US 2011/0142528 A1
(43) Pub. Date: Jun. 16, 2011

(54) BINGO DAUBER

(76) Inventor: David E. Charlton, Las Vegas, NV (US)

(21) Appl. No.: 12/949,649

(22) Filed: Nov. 18, 2010

Related U.S. Application Data
(60) Provisional application No. 61/281,545, filed on Nov. 19, 2009.

(51) Int. Cl. B05C 21/00

(52) U.S. Cl. 401/196

(57) ABSTRACT

A bingo dauber configured to receive the finger of a user such that the bingo dauber is worn on and controlled by the finger of the user. At least one opening in the bingo dauber is configured to receive a finger (e.g., index finger) which extends into a finger receiving channel and groove arrangement, or finger insert defining a finger receiving channel, allowing the bingo dauber to be used quickly with a single finger while reducing or eliminating fatigue associated with gripping a conventional ink dauber. The bingo dauber includes an ink reservoir and porous membrane for dispensing ink onto a bingo card.

### CROSS-REFERENCES

This application claims priority to U.S. Provisional Patent Application No. 61/281,545 filed Nov. 19, 2009.

### FIELD OF THE INVENTION

The embodiments of the present invention relate to a bingo dauber configured to be worn on a user's finger.

### BACKGROUND

Bingo is a multi-billion dollar international business. Depending on the jurisdiction, bingo may be played for money or entertainment. When played in a live setting, players purchase one or more bingo cards and daub called numbers on each of the one or more bingo cards until a winner is declared. Conventional bingo daubers comprise a cylindrical housing containing a reservoir of colored ink which is dispensed through a circular, porous membrane (e.g., foam) at one end thereof. Thus, when used the dauber creates a circular ink blotch which covers called bingo numbers on the bingo cards. The circular, ink blotches provide an easy mechanism for identifying a winning bingo card.

Despite the popularity of the conventional ink daubers and given the desire of players to play large numbers of bingo cards at one time, there exists the need for a new ink dauber with increased comfort and allows faster and more efficient use. Advantageously, the ink dauber should be subject to various different ornamental appearances.

### SUMMARY

Accordingly, the embodiments of the present invention are directed to a bingo dauber configured to receive the finger of a user such that the bingo dauber is worn on and controlled by the finger of the user. At least one opening in the bingo dauber is configured to receive a finger (e.g., index finger) which extends into a channel and groove arrangement, or finger insert, allowing the bingo dauber to be used quickly with a single finger while reducing or eliminating fatigue associated with gripping a conventional ink dauber.

In one embodiment, the dauber is ornamentally configured as an animal, fireman or any other desired shape. In this manner, users are able to personalize their bingo space by using one or more daubers with one or more different ornamental appearances.

Other variations, embodiments and features of the present invention will become evident from the following detailed description, drawings and claims.

### BRIEF DESCRIPTION OF THE DRAWINGS

FIGS. 1a and 1b illustrate side and upper perspective views, respectively, of a conventional bingo dauber according to the prior art;

FIG. 2a illustrates a front view of a firemen bingo dauber according to the embodiments of the present invention;

FIG. 2b illustrates a perspective view of a firemen bingo dauber according to the embodiments of the present invention;

FIG. 2c illustrates a rear view of a firemen bingo dauber according to the embodiments of the present invention;

FIG. 2d illustrates a bottom view of a firemen bingo dauber according to the embodiments of the present invention;

FIG. 2e illustrates a cross-sectional view of a firemen bingo dauber according to the embodiments of the present invention;

FIG. 3 illustrates a cross-sectional view of another bingo dauber according to the embodiments of the present invention;

FIGS. 4a through 4d illustrate exploded and integrated views of a dauber according to the embodiments of the present invention;

FIGS. 5a through 5c illustrate a finger inserted into a bingo dauber according to the embodiments of the present invention;

FIGS. 6a and 6b illustrate a bingo dauber according to the embodiments of the present invention; and

FIGS. 7a and 7b illustrate bingo daubers having ornamental appearances of animals according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The embodiments of the present invention are directed to a bingo dauber configured to be worn on the finger of a user. The bingo dauber may take on any ornamental appearance without departing from the scope and spirit of the present invention.

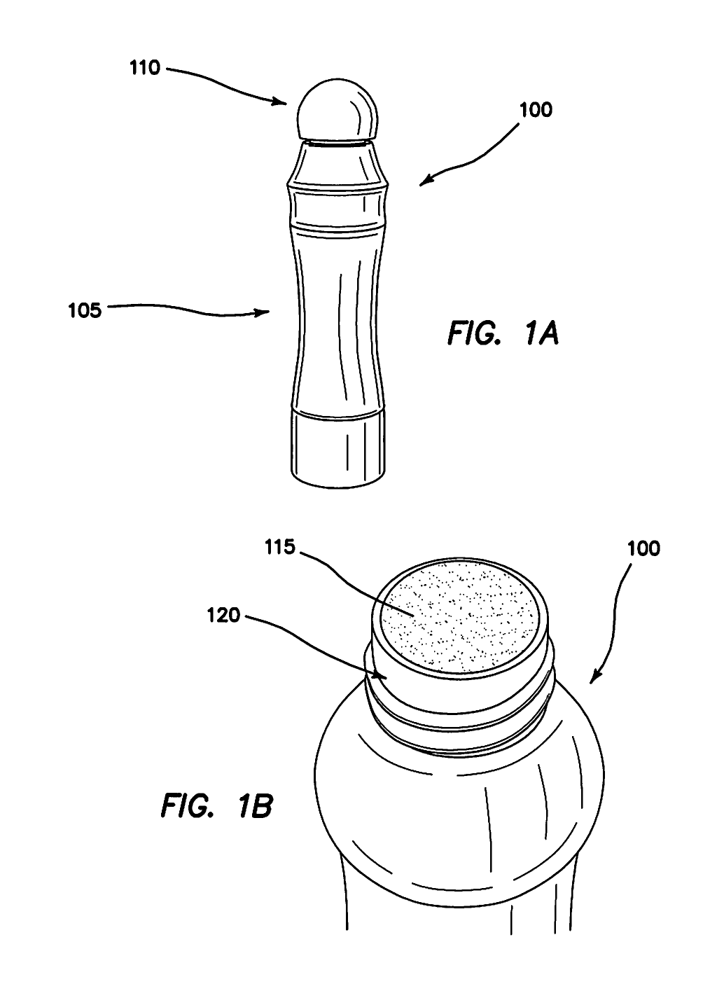

FIG. 1a shows a conventional bingo dauber 100 in a closed configuration according to the prior art. The bingo dauber 100 is generally cylindrical in shape and includes a housing 105 and cap 110. The housing 105 defines or conceals an ink reservoir. That is, the inner surface of the housing may serve as a portion of the ink reservoir or the ink reservoir may be a separate item completely contained within the housing. FIG. 1b shows an upper view of the conventional bingo dauber 100 with the cap 110 removed thereby exposing a porous membrane (e.g., foam) 115 which allows contained ink to be dispensed onto bingo cards. The upper portion 120 is threaded to facilitate attachment and removal of the cap 110.

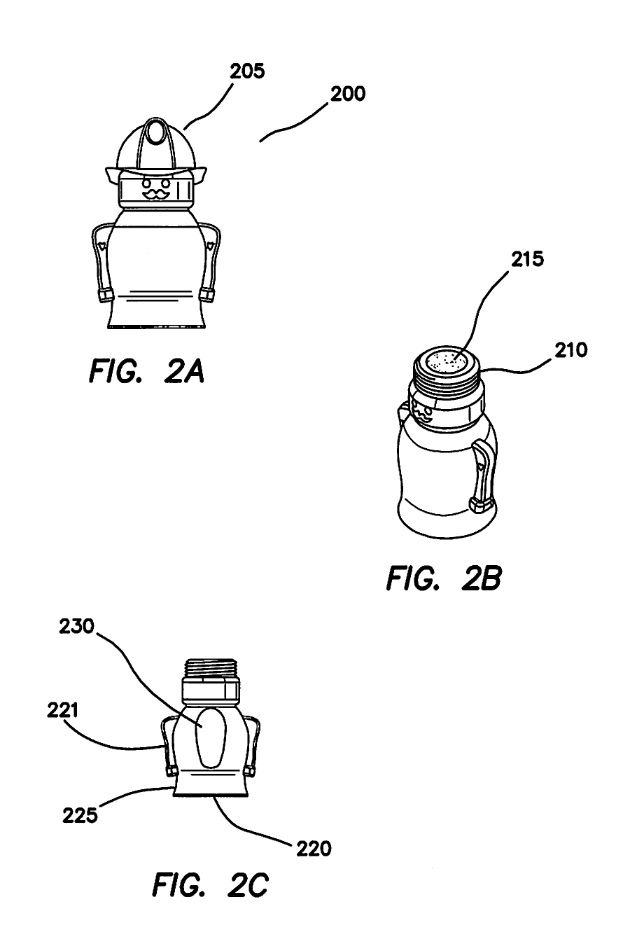

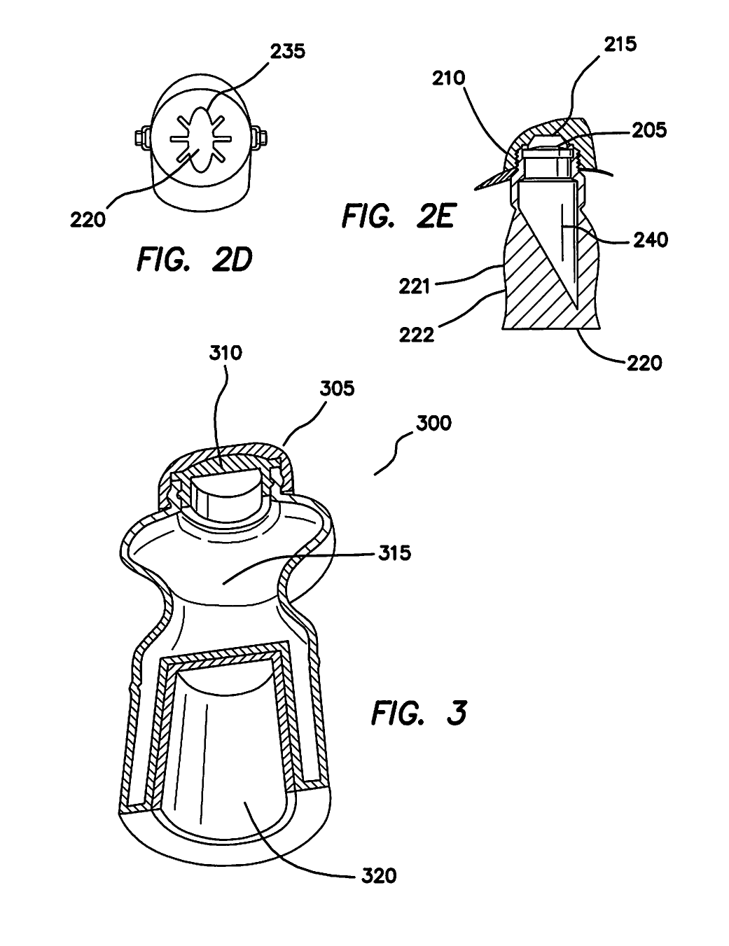

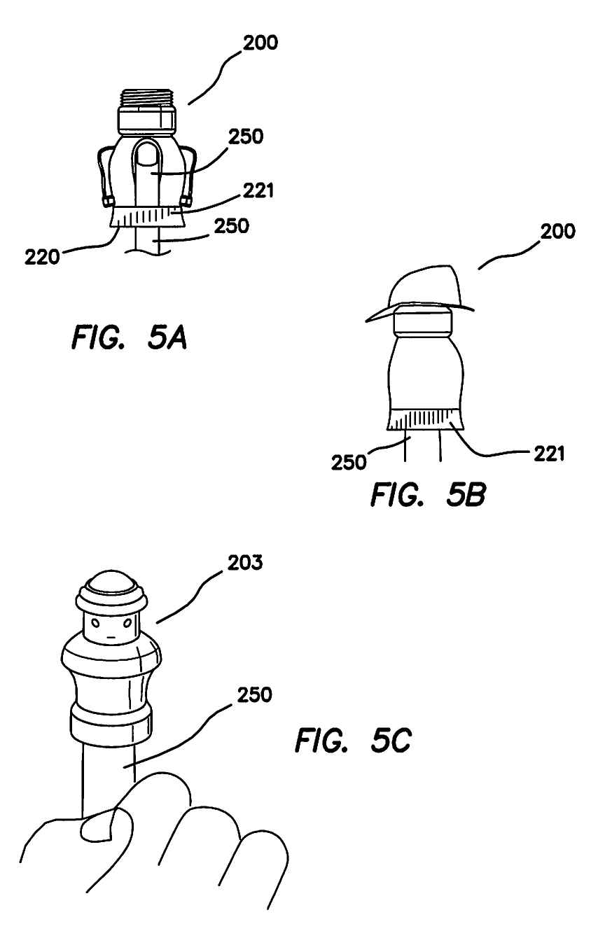

FIGS. 2a through 2e show various views of a bingo dauber 200 according to the embodiments of the present invention. FIG. 2a shows a front view of a fireman bingo dauber 200 according to the embodiments of the present invention. Those skilled in the art will recognize that the bingo dauber 200 can take on any form and shape (e.g., a cat). FIG. 2b shows the bingo dauber 200 with a cap 205 removed. In this configuration, the cap 205 is configured as a fireman's helmet. As shown, a threaded portion 210 of the bingo dauber 200 serves to facilitate attachment and removal of the cap 205. That is, the cap 205 includes a threaded recess compatible with the threaded portion 210. With the cap 205 removed, a porous membrane 215 such as foam is exposed allowing ink from within an ink reservoir to be daubed on bingo card numbers. FIG. 2c shows a rear view of the bingo dauber 200. A first opening 220 in the bottom 225 of the bingo dauber 200 receives a user's finger which is able to extend to and through a second opening 221. The first opening 220 and second opening 221 are separated by a finger receiving channel 222. A finger groove 230 having a generally concave shape runs along the rear of the dauber 200 to provide a resting or accommodation area for the user's finger inserted through said channel. The finger groove 230 also facilitates the user's ability to control the bingo dauber 200 with a single finger. FIGS. 5a through 5b show the bingo dauber 200 on a finger. FIG. 2d shows a bottom view of the dauber 200 including first opening 220 and finger web 235 positioned thereover to accommodate and retain fingers of different sizes. The finger web 235 is made of any pliable material, such as rubber, polyurethane, etc., suitable for allowing a finger to insert therethrough and generally retaining the finger thereby maintaining the bingo dauber 200 on the finger of a user. FIG. 2e shows a cross-sectional view of the bingo dauber 200 including cap 205, threaded portion 210, porous membrane 215, ink reservoir 240 and openings 220, 221.

FIG. 3 shows a cross-sectional view of another dauber 300 according to the embodiments of the present invention. In this embodiment, a finger insert 320 defining a finger receiving channel extends into, and is completely concealed within, the dauber 300 (i.e., there is no second opening). The cross-sectional view shows cap 305, porous membrane 310, ink reservoir 315 and finger insert 320. For comfort, the finger insert 320 is lined with or fabricated of neoprene, rubber, vinyl, polymer or similar soft, pliable and/or comfortable material. While not shown, a finger web may also be incorporated near the opening in the finger insert 320.

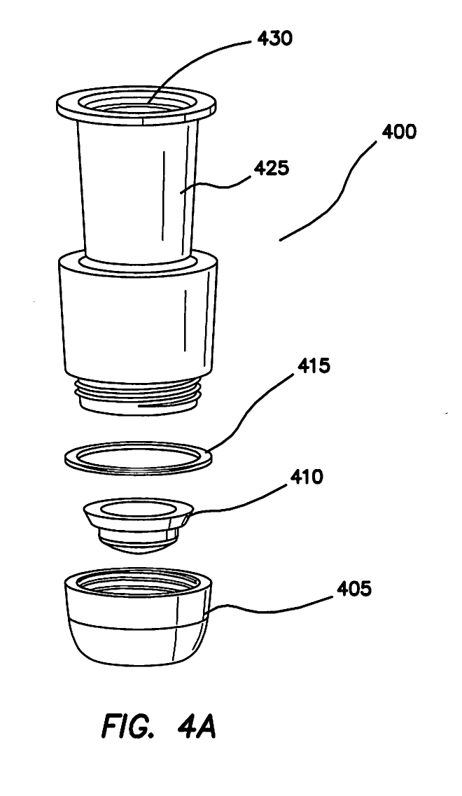

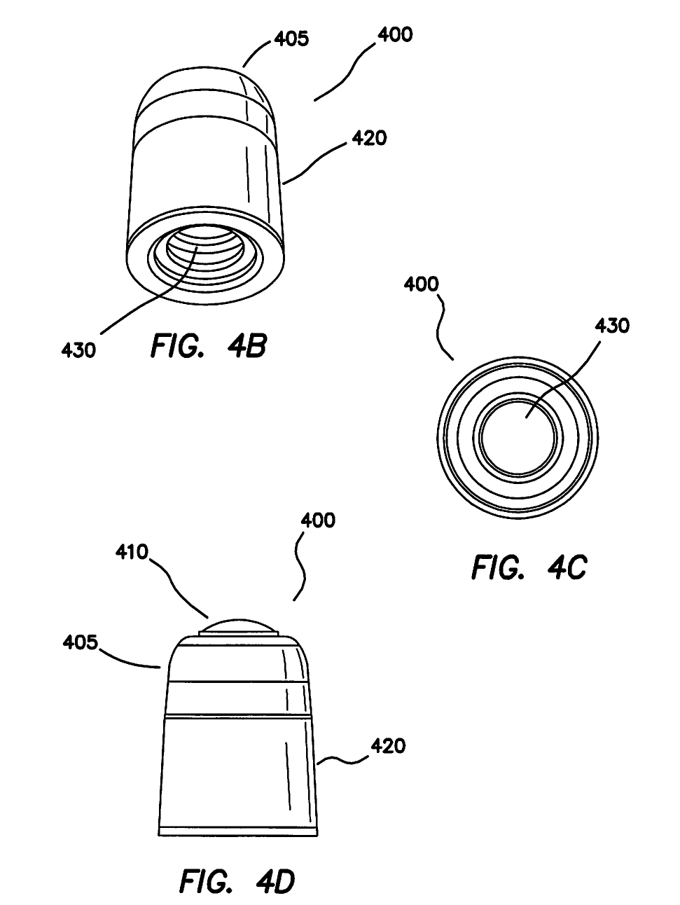

FIGS. 4a through 4d show exploded and integrated views of a bingo dauber 400 according to the embodiments of the present invention. The dauber 400 comprises at least a cap 405, porous membrane 410, gasket 415, housing 420 and finger insert 425 having finger opening 430. An ornamental housing may receive the bingo dauber 400 to create an ornamentally pleasing final product. It is also conceivable that the bingo dauber 400 may be configured to function akin to lip stick whereby twisting a portion of the cap 405 exposes the porous membrane 410 out of the top of the bingo dauber 400.

FIGS. 5a and 5b show rear and side views, respectively, of a finger 250 inserted through first opening 220, which may be partially covered by the finger web 235, and through second opening 221 of bingo dauber 200 until the front of the finger 250 rests on groove 230. In this manner, the finger 250 is able to control use of the bingo dauber 200. FIG. 5c shows the finger 250 inserted into a finger insert 425 like that shown in FIG. 4a of bingo dauber 203 which does not include the second opening or groove. Regardless of the embodiment, the bingo dauber of the present invention receives a finger which controls use of the bingo dauber.

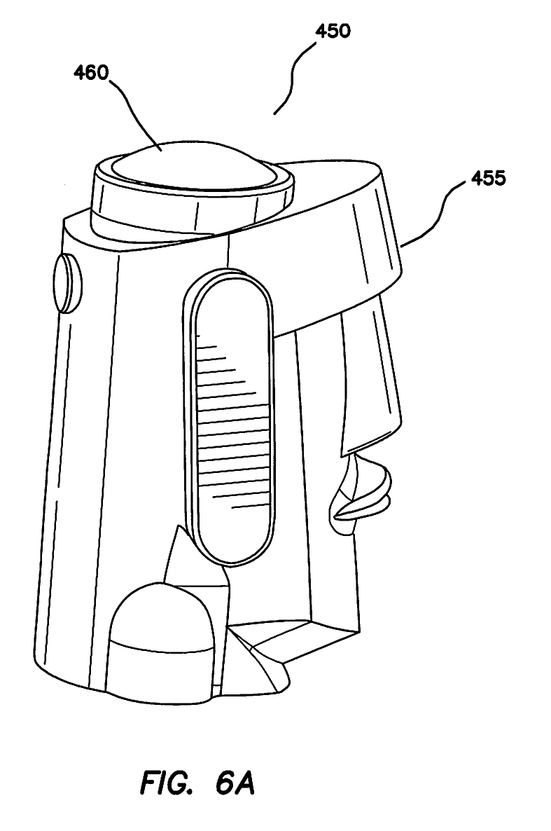

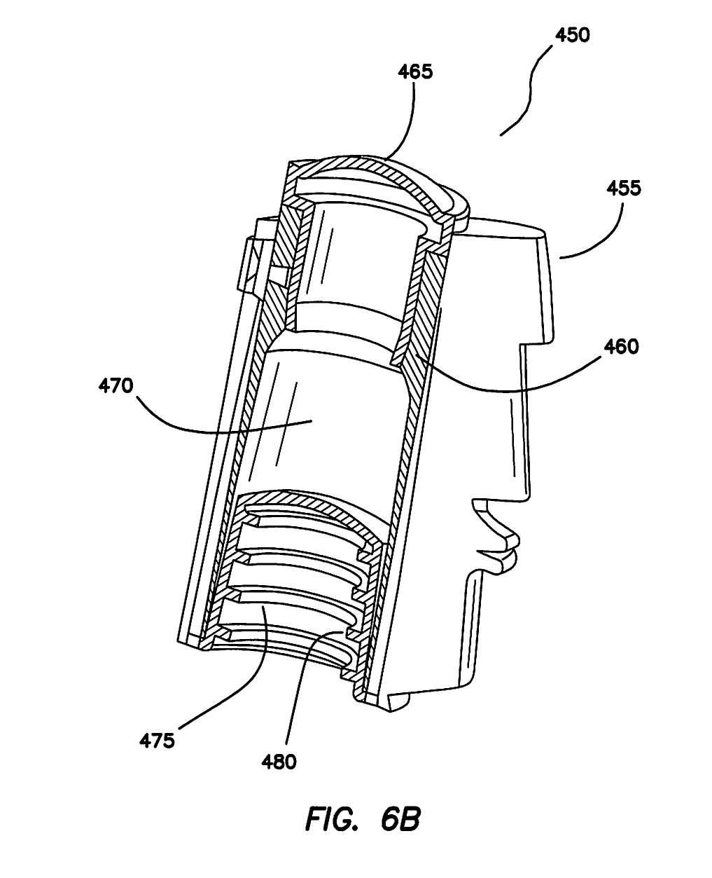

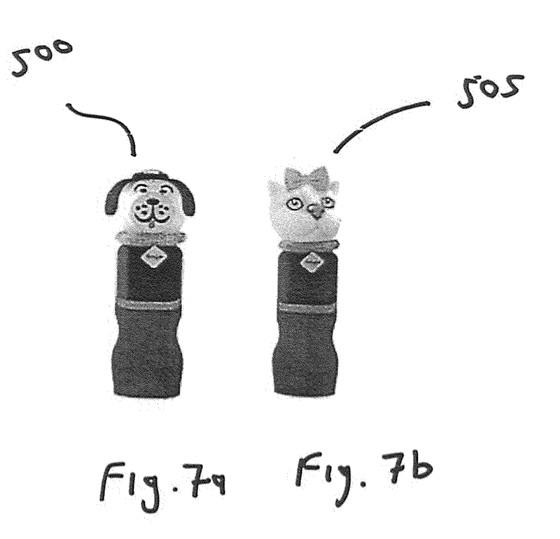

FIGS. 6a and 6b show perspective and cross-sectional views of a dauber 450 according to the embodiments of the present invention. The dauber 450 is configured to have the appearance as a tiki. In this embodiment, a tiki façade 455 contains the functional portions of the bingo dauber 450 including housing 460, porous membrane 465, ink reservoir 470 and finger insert 475 defining a finger receiving channel. Ridges 480 integrated on the finger insert 470 provide tactile feedback allowing a user to control the bingo dauber 450 with a single finger.

FIGS. 7a and 7b show bingo daubers 500 and 505 configured as a dog and cat, respectively, according to the embodiments of the present invention. The bingo daubers according to the embodiments of the preset invention may be ornamentally configured in any conceivable manner.

Any of the bingo daubers detailed herein and within the embodiments of the preset invention can be configured to be refillable. In one embodiment, the porous membrane is removable such that the ink reservoir may be filled with ink.

Although the invention has been described in detail with reference to several embodiments, additional variations and modifications exist within the scope and spirit of the invention as described and defined in the following claims.

I claim:

1. A bingo dauber comprising:
a housing;
a porous membrane;
an ink reservoir within said housing such that ink is able to flow to and through said porous membrane; and
a finger receiving channel within said housing accessible via at least one opening configured to receive a finger.

2. The bingo dauber of claim 1 wherein said at least one opening is opposite said porous membrane.

3. The bingo dauber of claim 1 further comprising a finger web near said at least one opening.

4. The bingo dauber of claim 1 further comprising a series of grooves along said finger receiving channel.

5. The bingo dauber of claim 1 wherein said finger receiving channel includes one or more ridges.

6. A bingo dauber comprising:
a housing;
a porous membrane;
an ink reservoir within said housing such that ink is able to flow to and through said porous membrane;
a first and second opening separated by a finger receiving channel; and
a finger groove adjacent to one of said openings such that a finger inserted through said channel is accommodated by said groove.

7. The bingo dauber of claim 6 further comprising a finger web near said first opening.

8. The bingo dauber of claim 6 wherein said finger groove is concave in shape.

9. The bingo dauber of claim 6 wherein said finger groove is on a back of said housing.

10. A bingo dauber comprising:
a housing;
a porous membrane;
an ink reservoir within said housing such that ink is able to flow to said porous membrane; and
a finger insert configured for receipt of a finger, said finger insert at least partially contained by said housing.

11. The bingo dauber of claim 10 further comprising a finger web near an opening in said finger insert.

12. The bingo dauber of claim 10 wherein said finger insert is fabricated of a pliable material.
